(19) United States
(12) Patent Application Publication
(10) Pub. No.: US 2011/0181964 A1
(43) Pub. Date: Jul. 28, 2011

(54) MAGNIFYING GLASS

(75) Inventors: Klaus Henkelmann, Rothenbach (DE); Wolfgang Gilgert, Nurnberg (DE); Martin Schillnger, Munchen (DE)

(73) Assignee: ESCHENBACH OPTIK GMBH, Nurnberg (DE)

(21) Appl. No.: 13/014,338

(22) Filed: Jan. 26, 2011

(30) Foreign Application Priority Data
Jan. 26, 2010 (DE) 10 2010 001 227.0

(51) Int. Cl. G02B 25/00; G02B 13/18; G02B 11/02

(52) U.S. Cl. 359/718; 359/796

(57) ABSTRACT

A magnifying glass has an eye-side aspherical biconvex-lens and an object-side meniscus lens, the concave lens surface of which faces a field of vision. This produces a magnifying glass, which is flexible to use and at the same time is not complex in its design.

### FIELD OF THE INVENTION

The invention relates to a magnifying glass.

### BACKGROUND OF THE INVENTION

Such magnifying glasses are known as stand magnifiers for placing on an object to be enlarged, for example a newspaper, and as a hand-held magnifier or hand-held reading device, for example from the Wikipedia entry for the term “magnifying glass” dated 18 Nov. 2009.

### SUMMARY OF THE INVENTION

An objective of the present invention is to develop a magnifying glass such that it is not complex but has a defined flexibility of use.

Said objective is achieved according to the invention by a magnifying glass with an eye-side biconvex-lens, with an object-side meniscus lens, the concave lens surface of which faces a field of vision.

The magnifying glass according to the invention can be designed as a stand magnifier or as a hand-held magnifier. The height of the magnifying glass can be less than 50 mm and can be in particular 40 mm, and can even be less than 40 mm or 35 mm and even just 32 mm. With the magnifying glass according to the invention a larger scale image can be achieved when in use than with a stand magnifier or also a high degree of enlargement can be achieved when in use as a hand-held reading device. The optical system of the magnifying glass according to the invention with the biconvex-lens and the meniscus lens can be designed so that the view through the magnifying glass is more comfortable. Embodiments are possible with an object location and/or an image location a short distance from the magnifying glass.

In a magnifying glass comprising exactly two optical components, namely the biconvex-lens (8) and the meniscus lens an optical system is produced with comparatively low production costs. Such a magnifying glass comprises exactly two optical components which are manufactured separately from each other.

An optical design such that an enlarging imaging scale is produced which is at least 2 is adjusted effectively to the respective purpose. The image scale is the ratio between the size of the image in the eye of the viewer and the size of the object to be enlarged by the magnifying glass. The scale of the image is thus the ratio between an image size and an object size.

An aspherical biconvex-lens designed as an aspherical lens and in particular having exactly one aspherical optical surface improves the image properties of the magnifying glass. The biconvex lens preferably designed with exactly one aspherical optical surface can be produced at very little cost. The non-aspherical optical surface of the biconvex-lens, i.e. the spherical surface, is inexpensive to produce. Variable distances between the biconvex-lens and the meniscus lens and between the meniscus lens and an object plane of the magnifying glass, in which the field of vision (11) lies, enable the use of the magnifying glass as a zoom-magnifying glass. The variability of the distances can also be achieved in combination.

A magnifying glass in which the biconvex-lens and the meniscus lens for the user are connected together detachably increases the flexibility of use of the magnifying glass further. The connection of the two lenses can be designed as a magnetic, plug-in or screw connection. The connection can be designed such that no tool is necessary for releasing the lenses. The detachable connection can be used if necessary in order to use the magnifying glass with only one of the two lenses respectively, i.e. for example only with the biconvex-lens or only with the meniscus lens, and to remove the other of the two lenses. In particular, the biconvex-lens can be used as a hand-held magnifier. Alternatively or in addition it is possible to exchange one of the lenses or both lenses with an additional lens from a reserve set of lenses, in order in this way to modify the image properties of the magnifying glass in a specific manner.

Exemplary embodiments of the invention are explained in more detail in the following with reference to the drawing.

### BRIEF DESCRIPTION OF THE DRAWINGS

FIG. 1 shows in perspective a zoom-stand magnifier for resting on a surface to be enlarged, for example a newspaper;

FIG. 2 shows in a meridional section an optical system for a stand magnifier according to FIG. 1 with a fixed image scale;

FIG. 3 shows in a view similar to FIG. 2 a further embodiment of an optical system for an additional embodiment of the stand magnifier with a variable image scale;

FIG. 4 shows in a view similar to FIG. 1 a further embodiment in the form of a hand-held reading glass; and

FIGS. 5 to 8 show various embodiments of lens systems for use in a magnifying glass, which can be designed as a stand magnifier or as a hand-held reading glass.

### DESCRIPTION OF THE PREFERRED EMBODIMENTS

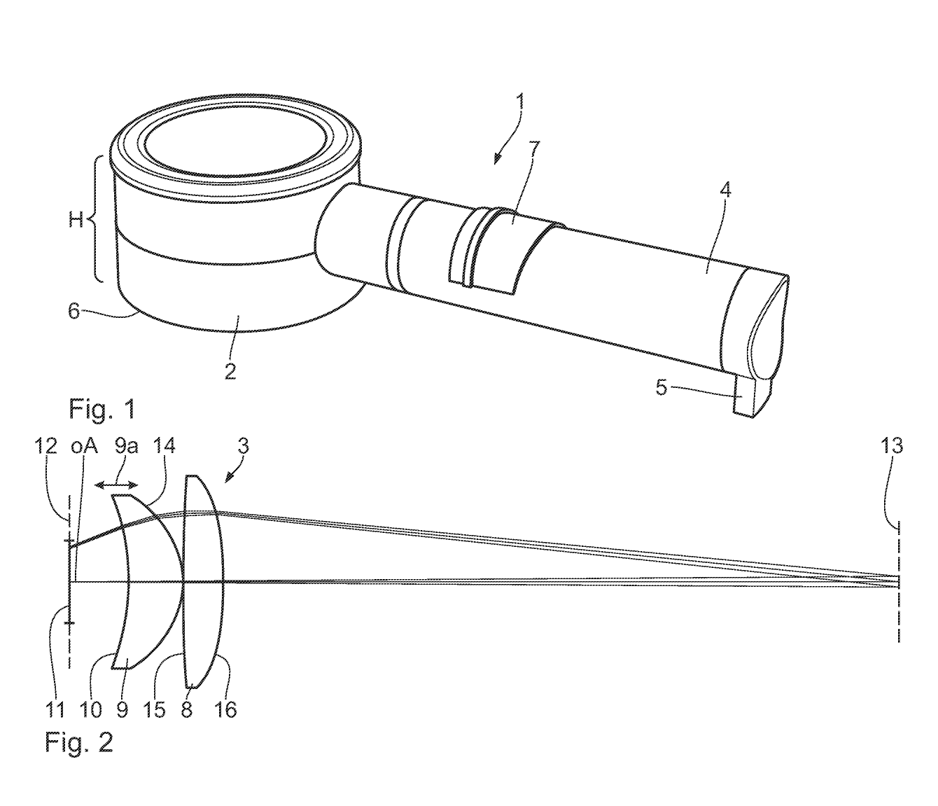

A magnifying glass 1 according to FIG. 1 is designed as a zoom-stand magnifier for placing on a surface to be enlarged, e.g. a newspaper. The magnifying glass 1 has a magnifying glass head 2, in which an optical system 3 (cf. FIG. 2) is accommodated, which is described in more detail in the following. The magnifying glass 1 has a handle 4. At the free end of the handle 4 a support foot 5 is designed for supporting the handle 4 for example on the surface to be enlarged or other base. In addition to the support foot 5 a support wall 6 lying on the base to be enlarged is used for supporting the magnifying glass 1 on the base to be enlarged.

The handle 4 has an activating element 7, with which for example a light can be activated for a field of vision of the magnifying glass 1. The activating element 7 can also be used alternatively or in addition to target a zoom factor of the magnifying glass 1.

The optical system 3 has an eye-side aspherical biconvex-lens arrangement in the form of a biconvex-lens 8 and an object-side meniscus lens 9, the concave lens surface 10 of which faces the field of vision 11 of the magnifying glass 1. The magnifying glass 1 with the optical system 3 can be operated with a fixed image scale of 3.54. In one variant of the magnifying glass 1 the meniscus lens 9, as shown in FIG. 2 by a double arrow 9a, can be adjusted in its distance from the biconvex lens 8 which is fixed in relation to the field of vision 11, so that a zoom-effect is produced. This displacement can take place by means of an activating wheel on the magnifying glass head 2.

The following table 1 shows characteristics of the optical design of the optical system 3.

| | | | Optical ma- | Diam- | |
|---|---|---|---|---|---|
| Surface | Radius | Thickness | terial | eter | E |
| Object plane | | 17 | | 0 | 0 |
| S1 | −80 | 16 | PMMA | 52 | 0 |
| S2 | −29.1 | 0.5 | | 52 | 0.025 |
| S3 | 364 | 13.5 | PMMA | 63 | 0 |
| S4 | −57.25 | 200 | | 63 | −0.3329002 |
| Pupil plane | | −321.81 | | 3 | 0 |

The object plane is in this case the plane 12 in which the field of vision 11 is arranged.

The first column “surface” of table 1 shows according to the object plane 12 the sequence of the optical surfaces of the two lenses 9 and 8 from the field of vision 11. The first surface S1 is in this case the concave lens surface 10 of the meniscus lens 9. In the beam path of the image light between the field of vision 11 and an eye-side pupil plane 13 of the optical system 3 there follows a convex lens surface 14 of the meniscus lens 9 as surface S2 according to table 1, a convex lens surface 15 of the biconvex-lens 8 as surface S3 according to table 1 and a convex lens surface 16 of the biconvex-lens 8 as surface S4 according to table 1. The column “radius” of table 1 indicates a main curvature radius or vertex radius R of the respective optical surface. The column “thickness” indicates the distance of a vertex point of the respective surface to the vertex point of the respective preceding surface. The column “material” indicates the material of the two lenses 8, 9, in the case of the embodiment according to FIG. 2 PMMA (polymethyl methacrylate). The column “diameter” indicates the respectively optically relevant diameter of the optical surface. The column “E” indicates the value of a conical constant for the respective optical surface.

The optical surfaces S1 to S4 according to table 1 consist of spherical or aspherical surfaces according to the following surfaces according to the following aspherical formula:

$$z ( y ) := \frac{\frac{{y}^{2}}{R}}{1 + \sqrt{1 - ( 1 + E ) \cdot {( \frac{y}{R} )}^{2}}} + A 4 \cdot {y}^{4} + A 6 \cdot {y}^{6} + A 8 \cdot {y}^{8} + A 10 \cdot {y}^{10}$$

In this case:
z(y) is the arrow height (sagitta) of the respective optical surface at distance y to an optical axis oA;
R is the aforementioned radius of curvature;
E is the aforementioned conical constant;
A4, A6, A8, A10 denote the coefficients characterizing the respective asphericity.

In the case of the optical system 3 the aspherical coefficients A4, A6, A8 and A10 are zero respectively. Depending on the size of the field of vision 11 and depending on the size of the required image scale the coefficients A4, A6, A8 and A10 also have values which are different from zero, so that a corresponding asphericity of the optical surface is obtained.

In an additional embodiment of the optical system 3 according to FIG. 2 the image scale is 2.95. The following table 2 indicates the optical data of the optical system 3 with said additional image scale.

TABLE 2

| | | | Optical mate- | Diam- | |
|---|---|---|---|---|---|
| Surface | Radius | Thickness | rial | eter | E |
| Object plane | | 17 | | 0 | 0 |
| S1 | −80 | 16 | PMMA | 52 | 0 |
| S2 | −29.1 | 0.5 | | 52 | 0.025 |
| S3 | 364 | 12.0 | PMMA | 63 | 0 |
| S4 | −69.59 | 200 | | 63 | 0.2 |
| Pupil plane | | −299.79 | | 3 | 0 |

The magnifying glass 1 has exactly two optical components, namely the lenses 8 and 9.

The biconvex-lens 8 has in the design according to FIG. 2 an aspherical optical surface. The latter can be the entry surface or the outlet surface of the biconvex-lens 8. The other of the two optical surfaces of the biconvex-lens 8 is spherical in this case. In a not shown embodiment the biconvex-lens 8 has two aspherical optical surfaces.

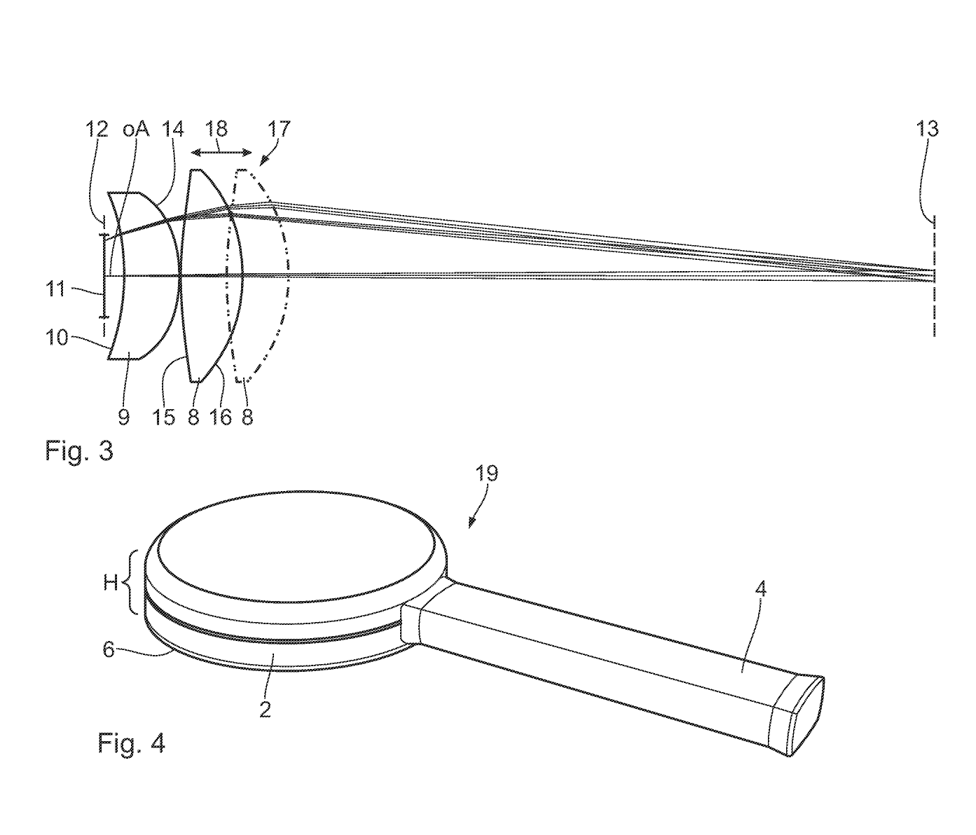

FIG. 3 shows a further embodiment of an optical system 17, which can be used instead of the optical system 3 with the magnifying glass 1. Components, which correspond to those which have already been explained above with reference to FIGS. 1 and 2, have the same reference numerals and are not discussed again in more detail.

In the optical system 17 the distance between the biconvex-lens 8 and the meniscus lens 9 is made to be variable by a displacement of the biconvex lens 8 along the optical axis oA. This is shown in FIG. 3 by a double arrow 18 and by a representation of the biconvex-lens 8 in the two extreme mounting positions, i.e. in the displacement position, in which the distance between the lenses 8, 9 is minimal, and in the displacement position in which the distance between the lenses 8 and 9 is at its maximum. The distance between the two lenses 8 and 9 can be varied in a range between 0.5 mm and 14 mm. This results in an associated variation of the image scale between the values 2.2 and 3.4. The magnifying glass 1 with the optical system 17 can thus be used as a zoom-stand magnifier.

The following table 3 shows characteristics of the optical design of the optical system 17.

TABLE 3

| | | | Optical mate- | Diam- | |
|---|---|---|---|---|---|
| Surface | Radius | Thickness | rial | eter | E |
| Object plane | | 6 | | 0 | 0 |
| S1 | −60 | 15.95 | PMMA | 44 | 0 |
| S2 | −35.23 | 0.5-14 | | 48 | 0.95 |
| S3 | 149 | 18 | PMMA | 63 | −16.24 |
| S4 | −43.66 | 200 | | 63 | −0.7414 |
| Pupil plane | | −259.3 | | 3 | 0 |
| | | −325.6 | | | |

In the optical system 17 the surface S4, i.e. the lens surface 16 of the biconvex-lens 8, has the following aspherical coefficients A6:

A6=8,7159682·10⁻¹¹

In the case of the optical system 17 with a variable distance between the lenses 8, 9 via the displacement 18, said displacement can be carried out via a rotary ring on the magnifying glass head 2 or via the activating element 7 in the handle 4 of the magnifying glass 1. For the displacement a mechanical internal gear can be used in particular. In principle, also a motor-driven displacement is possible, for example a servomotor with a downstream internal gear.

FIG. 4 shows a further variant of a magnifying glass 19 in the form of a hand-held reading glass. The magnifying glass 19 can be positioned freely between a surface to be enlarged and the eye, wherein a change in the enlargement and image scale can be varied by changing an object or eye distance, i.e. a distance of the optical system 3 or 17 of the magnifying glass 19 on the one hand from the object plane 12 and on the other hand from the pupil plane 13.

The magnifying glass 19 can use optical systems depending on the type of optical systems 3 and 17 explained above. The magnifying glass 19 can also be designed as an illuminated magnifying glass. A change in the enlargement can be achieved by a change in the form of the eye-side lens surface 16 of the biconvex-lens 8. This applies in principle to all of the described exemplary embodiments.

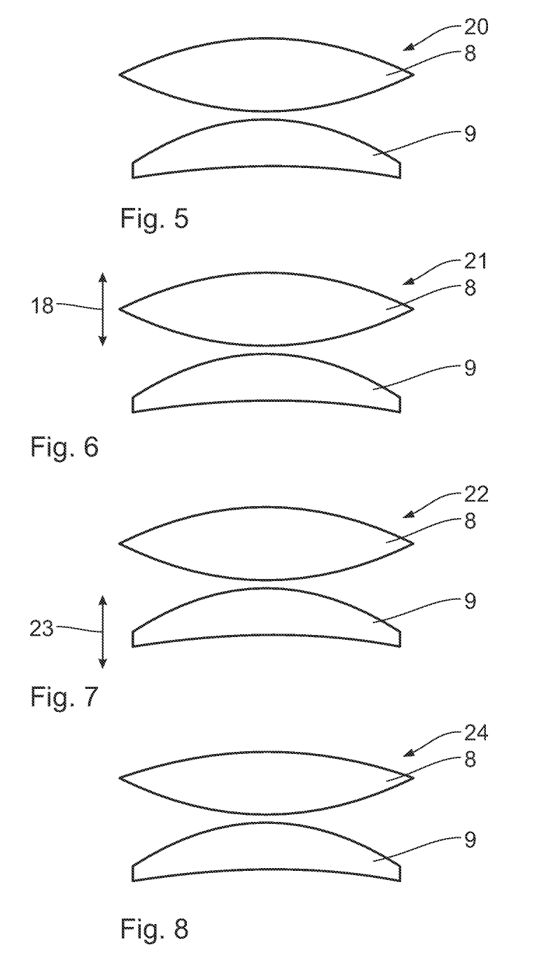

In the following with reference to FIGS. 5 to 8 additional design variants of optical systems are described, which instead of the optical systems 3, 17 already described above can be used in the magnifying glasses 1 or 19. Components, which correspond to those already described with reference to FIGS. 1 to 4, have the same reference numbers and are not discussed again in more detail.

FIG. 5 shows a layout of an optical system 20, which corresponds in principle to that of the optical system 3. The optical system 20 can be used in a stand magnifier according to the type of magnifying glass 1 or in a handheld device according to the type of magnifying glass 19. When in use in a stand magnifier an enlarging image scale of 2.4, 3.0 and 3.6 can be achieved for example. The height H (cf. FIG. 1) in the case of use of the optical system can be 20 to 40 mm.

The enlargement V of a hand-held device can be defined as

V=250 mm/f

In this case f is the focal distance of the respective optical system.

On using the optical system 20 as a hand-held reading device the latter can be used with a total focal distance of 10 dioptres, 12 dioptres or 14 dioptres. In the above enlargement formula a corresponding enlargement V is provided for the hand-held reading device.

FIG. 6 shows an optical system 21 according to the type of optical system 17. The optical system 21 can be used in a zoom-stand magnifier according to the type of magnifying glass 1. Heights H can be achieved when using the optical system 21 of in the region of between 38 mm and 50 mm. Accordingly a total displacement path for displacing the lens 8 (displacement arrow 18) can be 12 mm. An image scale can be varied on using the optical system 21 within a range of between 2.2 and 3.4.

FIG. 7 shows a design of an optical system 22, which can also be used in a zoom-stand magnifier for example instead of the optical system 21. Unlike the design with the optical system 21 according to FIG. 6 the design of a magnifying glass 1 with the optical system 22 according to FIG. 7 has a constant height H of 60 mm which is independent of the zoom-setting.

In the optical system 22 over a displacement path (double arrow 23) a distance can be varied between the meniscus lens 9 and the object plane 12, The total displacement area of the displacement 23 of the meniscus lens 9 is 12 mm. On the basis of the displacement 23 in the optical system 22 there is also a variable image scale in the region of between 2.2 and 3.4.

The displaceabilities 18 and 23 can also be achieved in a not shown embodiment of an optical system in combination. In this case the two lenses 8, 9 are designed to be displaceable in their distance from the object plane 12 along the optical axis oA.

FIG. 8 shows an optical system 24 for use in a hand-held reading glass according to the type of magnifying glass 19. The distance between the two lenses 8 and 9 is fixed in this case. A change in the actual image position can be varied according to the positioning of the optical system 24 between the object plane 12 and the pupil plane 13.

To change the optical properties of the optical systems 3, 17, 20 to 22 and 24 discussed above the two lenses 8 and 9 can be connected together detachably for the user. This makes it possible to use the individual lenses 8 or 9 with special applications instead of the whole optical system. A detachable connection of the two lenses 8 and 9 can also be used, to replace one of the lenses 8 and 9 with another lens 8′ or 9′, in order in this way to obtain a magnifying glass with other imaging properties. The two lenses 8 and 9 can be connected detachably to one another via a magnetic, plug-in or screw connection. The detachable connection is in particular such that no tool is necessary for detaching the two lenses 8, 9 from one another.

The magnifying glasses 1 and 19 ensure a binocular view. Depending on the design of the aforementioned optical systems a large eye spacing range and/or a large object spacing range can be ensured.

What is claimed is:

1. A magnifying glass (1; 19)
with an eye-side biconvex-lens (8),
with an object-side meniscus lens (9), the concave lens surface (10) of which faces a field of vision (11).

2. A magnifying glass according to claim 1, wherein the latter comprises exactly two optical components, namely the biconvex-lens (8) and the meniscus lens (9).

3. A magnifying glass according to claim 1, comprising an optical design such that an enlarging imaging scale is produced which is at least 2.

4. A magnifying glass according to claim 1, wherein the biconvex-lens (8) is designed as an aspherical lens.

5. A magnifying glass according to claim 1, wherein the biconvex-lens (8) has exactly one aspherical optical surface.

6. A magnifying glass according to claim 1, wherein the distance between the biconvex-lens (8) and the meniscus lens (9) can be varied.

7. A magnifying glass according to claim 1, wherein the distance between the meniscus lens (9) and an object plane (12) of the magnifying glass (1; 19), in which the field of vision (11) lies, can be varied.

8. A magnifying glass according to claim 1, wherein the biconvex-lens (8) and the meniscus lens (9) for the user are connected together detachably.
